(19) United States
(12) Patent Application Publication
(10) Pub. No.: US 2008/0257858 A1
(43) Pub. Date: Oct. 23, 2008

(54) Container, Closure Means and Use Thereof

(75) Inventors: Per Abrahamsson, Odakra (SE); Per Gustafsson, Bjarred (SE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ECO LEAN RESEARCH & DEVELOPMENT A/S, Kopenhamn (DK)

(21) Appl. No.: 12/066,993

(22) PCT Filed: Sep. 15, 2006
(86) PCT No.: PCT/SE2006/001051

§ 371 Date: Mar. 14, 2008

(30) Foreign Application Priority Data
Sep. 19, 2005 (SE) 0502071-4

(51) Int. Cl. B65D 90/02; B67D 3/00

(52) U.S. Cl. 215/384; 222/536

(57) ABSTRACT

The invention relates to a container (1) for liquid contents, comprising a closure means for reclosing the container. The container has a pouring spout portion (6) made of two opposite side walls (2) and provided with a removable end flap (8). The closure means comprises a squeezing means (7), which is permanently arranged on said pouring spout portion (6) and comprises a first and a second leg (9, 10), which are joined to each other by a joining means (11). The closure means also comprises a connecting portion (20, 21) which is permanently connected to the pouring spout portion (6), and a joint means (19) which is arranged between the joining means (11) and the connecting portion (20, 21). The joint means allows mutual relative turning of the first and the second leg to open and close the squeezing means. The invention also relates to such a closure means for reclosing of a container, and use of such a closure means for opening and reclosing a container.

### FIELD OF THE INVENTION

The present invention relates generally to a container for liquid contents comprising a closure means for reclosing the container, such a closure means for reclosing a container, and use of such a closure means for opening and reclosing a container.

### BACKGROUND ART

Food containers whose contents are intended to suffice for more than one occasion have become increasingly common in the current society. To ensure that the contents of the container, once it has been opened, are affected as little as possible by exposure to the ambient air, it is necessary for the container to be reclosable.

A prior art reclosable container for liquid contents comprises an opening means in the form of threads and a corresponding screw cap. To open the container, the screw cap is unscrewed from the opening means, thus making the contents of the container accessible to the user. To reclose the container, the screw cap is screwed back on.

Another prior art reclosable container for liquid contents comprises a structure with a foldable lid. The lid covers an opening in the container. When the container is still unopened, the opening is covered with a protective strip. When opening the container for the first time, the lid is turned up and the protective strip is removed, after which the contents in the container are accessible. When the container is to be reclosed, the lid is turned down.

A drawback of the above-mentioned prior art reclosable containers is that they are relatively expensive and complicated to manufacture.

In addition, prior art closure means in the form of screw caps are relatively expensive, which also makes containers with such closure means relatively expensive.

A common feature of the two above described types of closure means is that they comprise making a hole in the container wall which must then be sealed to protect the contents in the unbroken state of the container. As a result, the cost of applying these types of closure means to containers is high since the application process is complicated.

A further drawback of prior art reclosable containers is that they are relatively bulky, which detracts from the economy in transporting the containers before filling.

### SUMMARY OF THE INVENTION

An object of the present invention is to provide an alternative to the above-mentioned prior art reclosable containers, which eliminates at least one of the above drawbacks.

To achieve this object, and also other objects that will be evident from the following description, there are provided according to the present invention a container having the features defined in claim 1, a closure means having the features defined in claim 8 and use thereof according to claim 9.

More specifically, according to one aspect of the present invention a container for liquid contents is provided, comprising a closure means for reclosing the container, said container having a pouring spout portion made of two opposite side walls and provided with a removable end flap. The container is characterised in that the closure means comprises a squeezing means permanently arranged on said pouring spout portion, said squeezing means comprising a first and a second leg which are joined to each other by a joining means, a connecting portion permanently connected to said pouring spout portion, and a joint means which is arranged between said joining means and said connecting portion to allow mutual relative turning of the first and the second leg in the joint means for opening and closing of the squeezing means, the squeezing means being movable to an open and a closed state respectively, and the squeezing means in its closed state being arranged to serve to compress said side walls.

According to the invention, a container is thus provided, which can be reclosed in a simple, quick and durable manner. An advantage is also that the manufacture of a reclosable container is simplified by the closure means being arranged on the outside of the container. Consequently, the walls of the container need not be broken to allow application of the closure means. This also eliminates the risk that the interior of the container is contaminated. The closure means thus need not be arranged on the container in manufacture of container blanks but may instead be arranged thereon in connection with filling of the container. This results in the advantage that the container blanks can be transported to the place of filling in an economical and space-efficient way.

A further advantage is that the closure means can be arranged on the container before, during or after the process of filling the container, thus increasing the options in the manufacturing process.

Another advantage is that the manufacturing cost of an inventive container will be relatively low. This is due to the facts that the manufacturing cost of the actual closure means will be relatively low since it can be manufactured in an extremely cost-effective manner, for instance by injection moulding, and that the closure means can relatively easily be applied to the container.

A further advantage is that a reliable, cheap and simple tamper-proof seal is provided for a reclosable container by the end flap, or the absence thereof, clearly indicating whether the container has been opened or not.

The squeezing means comprises a first and a second leg which are joined to each other by a joining means. It will be appreciated that the above used joining means need not be a well-defined, separate part of the squeezing means but can advantageously be made in one piece with the legs.

The squeezing means further comprises a joint means which is arranged between said joining means and said connecting portion to allow mutual relative turning of the first and the second leg in the joint means for opening and closing of the squeezing means. The turning which is performed by applying a force to the legs is preferably flexible, whereby the legs when relieved of force strive to return to their initial position, which is the closed position.

By the expression that the squeezing means is permanently arranged on the pouring spout portion of the container is meant in this text that the squeezing means is fixedly arranged in normal use and during its entire normal life.

By reclosing a container is meant in the present text that the container can be reclosed repeatedly after being opened for the first time, that is when the end flap has been removed.

Each leg may have a closing portion, which closing portions in the closed state of the squeezing means face each other for compression of said side walls. This allows tight reclosing which can ensure that the contents after opening of the container can keep the product durability as promised.

Said connecting portion may be arranged on at least one of the first and the second leg. Thus the closure means can be arranged in various ways on the container, which allows the design of the container to be greatly varied.

The squeezing means may comprise gripping portions to allow application of force to the legs for opening and closing of the squeezing means.

To permanently fasten the squeezing means to the container in a simple way, it can be arranged on said pouring spout portion by means of an adhesive. The adhesive may consist of, for instance, a hot-melt adhesive or an adhesive tape. The squeezing means may, as will be realised, also be permanently arranged in several other ways, for example by welding.

The squeezing means may further comprise a first locking means for locking the squeezing means in its closed state. This results in the advantage that the closure means, and thus also the container, can be closed in a simple and durable way. Correspondingly, the squeezing means may comprise a second locking means for locking the squeezing means in its open state. This allows the opening of the container to have a constant cross-section during the entire pouring motion, thus avoiding unnecessary spillage. The first and the second locking means advantageously have a snap-in function.

According to a second aspect of the present invention, a closure means is provided for reclosing a container for liquid contents. The closure means is characterised by a squeezing means comprising a first and a second leg which are joined to each other by a joining means, at least one connecting portion which is permanently connectable to a pouring spout portion made of two side walls of the container, adjacent to a removable end flap of the pouring spout portion, and a joint means which is arranged between said joining means and said connecting portion to allow mutual relative turning of the first and the second leg in the joint means for opening and closing of the squeezing means, the squeezing means being movable to an open and a closed state respectively, and the squeezing means in its closed state being arranged to serve to compress said side walls.

The embodiments which have been described above for the inventive container and which concern the closure means can also be applied to the present inventive closure means itself. Thus the advantages that are associated with the closure means of the inventive container are also obtained for the present inventive closure means. Therefore these advantages will not be mentioned again.

According to a third aspect of the present invention, use of the above-mentioned inventive closure means for opening and reclosing a container for liquid contents is suggested, said container having a pouring spout portion made of two opposite side walls and provided with a removable end flap.

### BRIEF DESCRIPTION OF THE DRAWINGS

Non-limiting embodiments of the present invention will now be described by way of example with reference to the accompanying drawings. Components having a similar function or similar purpose in the embodiments illustrated have throughout been given the same reference numerals.

FIG. 1 is a side view of a reclosable container according to the invention.

FIG. 2 illustrates an embodiment of an inventive closure means in its closed state without the container.

FIG. 3 illustrates the closure means according to FIG. 2 in its open state.

FIG. 4 illustrates the inventive closure means arranged on an opened container, the container being seen straight from the front.

FIG. 5 illustrates a second embodiment of a closure means in its open state, which is arranged on an opened container, the container being seen straight from the front.

FIG. 6 illustrates the closure means according to FIG. 5 in the closed state without the container.

FIG. 7 shows an injection-moulded carrier with a plurality of closure means according to said second embodiment.

### DESCRIPTION OF A PREFERRED EMBODIMENT

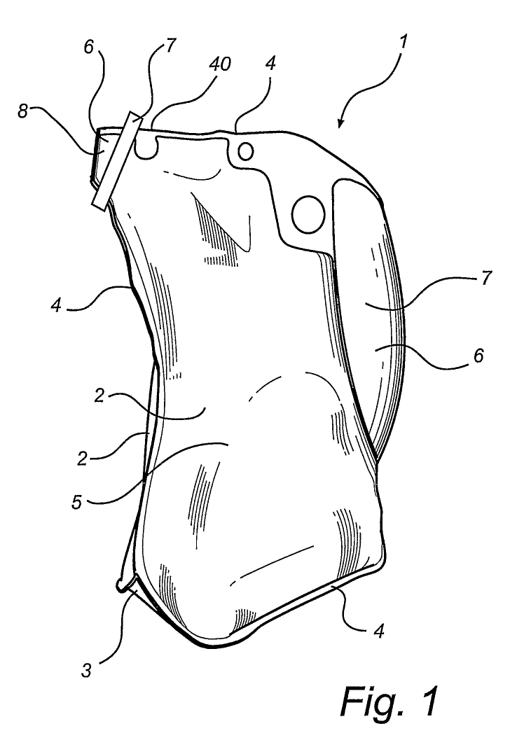

FIG. 1 illustrates a reclosable container for liquid contents, generally designated 1. The container 1 is of a collapsible type and comprises two opposite side walls 2 and a bottom wall folded into a double-wall structure, which, when filling the container 1, is unfolded to form an almost plane bottom wall 3. The walls 2, 3 are interconnected along a joining portion 4 and together define a compartment 5. The volume of the compartment 5 is dependent on the relative position of the flexible walls 2, 3. The container comprises a pouring spout portion 6, which has an end flap 8 that has to be removed by cutting, tearing or like operation to open the container 1. A closure means in the form of a squeezing means 7 is permanently arranged on the pouring spout portion 6 inside said end flap 8. The end flap 8 has the advantage that it acts as a tamper-proof seal since the end flap, or the absence thereof, clearly indicates whether the container 1 has been opened or not.

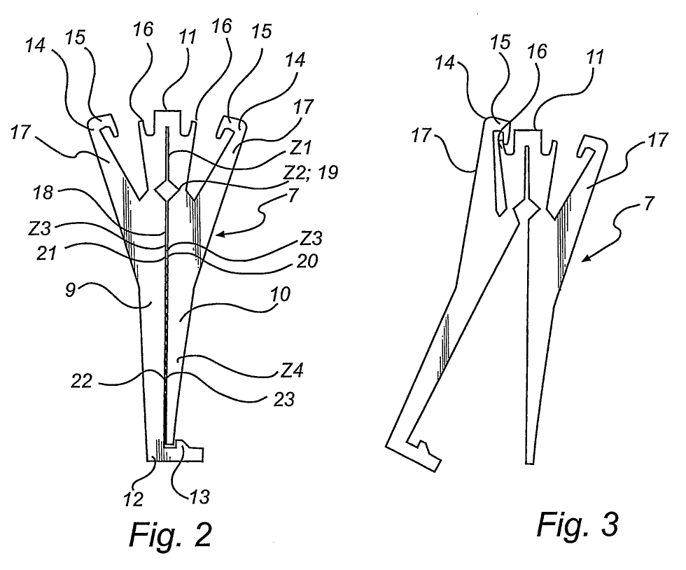

With reference to FIG. 2, a first embodiment of the inventive squeezing means 7 is shown in its closed state.

The squeezing means 7 which forms a clip consists of two legs 9, 10 which are joined to each other at an outer upper end by a joining means 11.

The first leg 9 has at its outer lower end a first locking means 12 in the form of a latch 13. The latch 13 is arranged to engage the outer lower end of the second leg 10, thereby locking the squeezing means 7 in a closed state.

The legs 9, 10 further have at their outer upper ends second locking means 14 in the form of latches 15. The latches 15 are adapted to cooperate with lugs 16 which are arranged on said joining means 11. More specifically, the latches 15 are arranged at the upper outer end of gripping portions 17 which are arranged in the form of protrusions on each leg 9, 10.

The two legs 9, 10 define between them a gap 18 which extends from said joining means 11 to the outer lower end of the closure means. The gap 18 can be divided into four zones, which zones will be described below.

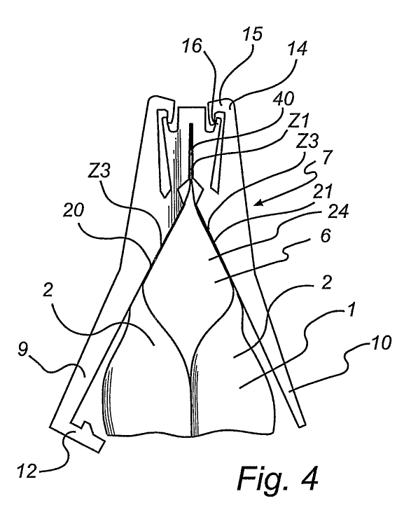

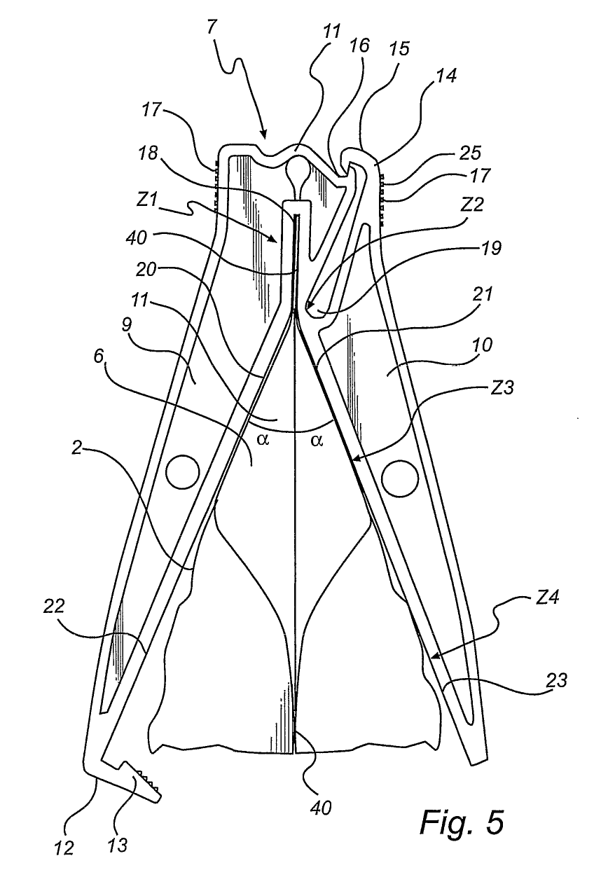

Beginning at the top, the first zone Z1 is arranged adjacent to said joining means 11. The first zone Z1 is adapted to accommodate part of the joining portion 40 of the container adjacent to the pouring spout portion 6 thereof when the squeezing means 7 is mounted on a container 1. This will be explained in more detail below with reference to FIGS. 1 and 4.

Below the first zone there is a second zone Z2 which constitutes a joint means 19 of the squeezing means 7. More specifically, the joint means 19 is a recess in the opposing surfaces of the legs 9, 10. The function of the joint means 19 will be described below with reference to FIG. 3. It will be appreciated that said joint means 19 can also be arranged on the outsides of the legs 9, 10, that is with a recess on the outside of each leg (not shown) to form a joint means with its function maintained.

Below the second zone Z2 there is formed a third zone Z3 in the form of connecting portions 20, 21. The connecting portions 20, 21 are adapted to be connected to the side walls of the pouring spout portion 6 for permanent arrangement of the squeezing means 7 on the container 1. More specifically, the squeezing means 7 is arranged on the outside of the side walls 2 of the container. To provide a good permanent connection to the container 1, the connecting portions 20, 21 are advantageously plane. The function of the connecting portions 20, 21 will be described below with reference to FIG. 4.

Finally, below said third zone Z3 there is a fourth zone Z4 in the form of closing portions 22, 23. The purpose of the closing portions 22, 23 is to ensure that the container 1 is closed in the closed state of the squeezing means 7.

For any contents that may have got stuck on the inside of the side walls in the pouring spout portion of the container to be pressed back, the squeezing means 7 can be provided with longitudinal bulges (not shown) on the opposing surfaces of the legs 9, 10 in the connecting portions 20, 21 and the closing portions 22, 23 or any of them. The bulges are preferably arranged on the side of the squeezing means which faces away from the compartment 5 of the container. It will be appreciated that the position, cross-section and extent of the bulges may be varied and that the bulges may advantageously be flexible.

The closing portions 22, 23 may further be provided with complementarily formed grooves and countersinks (not shown). In an alternative embodiment (not shown), the closing portion 22 of the first leg 9 may have a projecting section which is triangular in cross-section while the closing portion 23 of the second leg 10 may consist of a flat surface (not shown). Of course there are several other ways in which the closing portion can be formed. The important thing is that in the closed and locked state of the squeezing means 7, such compression of the pouring spout portion 6 of the container 1 is achieved that acceptable resealing is provided.

In the following the opening and locking function of the squeezing means 7 will be described with reference to FIG. 3.

To open the squeezing means 7, a force is applied to the gripping portions 17. Due to this force, the legs 9, are forced to be separated. More specifically, the legs 9, 10 are separated by turning in said joint means 19. The joint means 19 thus provides a hinge function. To lock the squeezing means in this opened position, at least one latch 15 of the second locking means 14 engages the associated lug 16 of the joining means 11, see FIG. 3.

Now referring to FIG. 4, and if such a squeezing means 7 is mounted on a container 1, the side walls 2 of the pouring spout portion 6 of the container are, in this position of the squeezing means 7, separated to provide an opening 24.

For the opening 24 in the container 1 to be symmetric, it is preferred for the second locking means 14 of both legs 9, 10 to be activated, that is both latches 15 engage the respective lugs 16, as shown in FIG. 4.

FIGS. 1 and 4, to which reference is now made, illustrate the squeezing means 7 which constitutes the closure means permanently arranged on the pouring spout portion 6 of the container 1. The squeezing means 7 is arranged so that an upper joining portion 40 of the container 1, see FIG. 1, is arranged in the first zone Z1 of the squeezing means, see FIG. 4. More specifically, part of the upper joining portion 40 is received in the gap that is formed between the two legs 9, 10 in this first zone Z1. The gap in the first zone Z1 preferably has such a width that the squeezing means 7 can easily be “slipped” onto the upper joining portion 40 of the container 1 in connection with the mounting of the squeezing means 7 on the container.

The squeezing means 7 is permanently connected to the side walls 2 of the container 1 via the connecting portions 20, 21 in said third zone Z3, see FIG. 4. More specifically, the connecting portions 20, 21 are permanently connected to the outside of the side walls 2 in the pouring spout portion 6.

The third zone Z3, that is the two connecting portions 20, 21, advantageously extends along half the length of the legs 9, 10 which is comprised by the third Z3 and the fourth Z4 zone, as is best illustrated in FIG. 4. Thus, the squeezing means 7 is preferably not connected to the pouring portion of the container along the fourth zone Z4, that is in the closing portions. This makes it possible to limit the opening 24 in the container without the squeezing means 7 at the same time being so small that it will be difficult to operate.

With special reference to FIG. 4, the squeezing means 7 should be arranged so that the first locking means 12 is arranged in the lower part of the pouring spout portion 6 and so that the joining means 11 is turned upwards towards the upper part of the container. When moving the legs 9, 10 apart while opening the squeezing means 7, the resulting opening 24 will thus be expanded and be at its largest in its lower part.

To open a container 1 for the first time, the end flap 8 is first torn or cut off from the pouring spout portion 6. After that the squeezing means 7 is opened by applying a force to the gripping portions 17, whereby the opposite side walls 2 of the pouring spout portion 6 are moved apart since the connecting portions 20, 21 are permanently arranged on them. To maintain the open state of the container, the squeezing means 7 is locked in its open state by allowing the latches 15 of the second locking means 14 to engage the associated lugs 16 which are arranged in the joining means 11. The container 1 is now open and the contents can easily be poured out of the container.

When reclosing the container, a bending outward force is applied to an upper part of the gripping portions 17, whereby the latches 15 of the second locking means 14 are disengaged from the lugs 16. The material of the squeezing means 7 preferably has such an inherent stability that the legs 9, 10 strive to return to their initial position, that is to the put-together state. As a result, the opening in the container is closed by the closing portions closing together and, between them, compressing the two side walls 2 in the opening portion 6 of the container. For a tight closure, a force is applied to the legs 9, 10 in the forth zone Z4, whereby the latch 13 of the first locking means 12 engages the lower end of the second leg 10. The squeezing means 7 is now in its closed, locked position and the container 1 is reclosed.

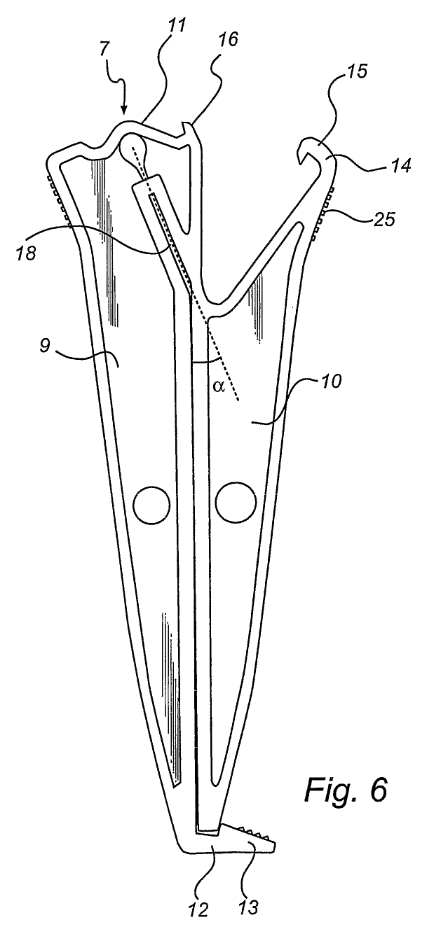

Reference is now made to FIGS. 5 and 6 which illustrate a second embodiment of the closure means. The closure means which is a squeezing means 7 is shown separately in its open and closed state respectively.

The squeezing means 7 consists of two legs 9, 10 which are joined to each other at an outer upper end by a joining means 11. The first leg 9 has at its outer lower end a first locking means 12 in the form of a latch 13. The latch 13 is adapted to engage the outer lower end of the second leg 10 in order to lock the squeezing means 7 in a closed state.

The second leg 10 further comprises at its outer upper end a second locking means 14 in the form of a latch 15. The latch 15 is adapted to cooperate with a lug 16 which is arranged on the joining means 11. Said outer upper end further forms a gripping means 25 in the form of a lever which will described in more detail below.

The two legs 9, 10 define between them a gap 18 which extends from said joining means 11 to the outer lower end of the closure means. The gap 18 can be divided into four zones, which zones will be described below with reference to FIG. 5.

Beginning at the top, the first zone Z1 is arranged adjacent to said joining means 11. The first zone Z1 is adapted to accommodate part of the joining portion 40 of the container adjacent to the pouring spout portion 6 thereof when the squeezing means 7 is mounted on a container 1.

Below the first zone there is a second zone Z2 which constitutes a joint means 19 of the squeezing means 7. More specifically, the joint means 19 is a recess in the outside of the second leg 10.

Below the second zone Z2 there is formed a third zone Z3 in the form of connecting portions 20, 21. The connecting portions 20, 21 are adapted to be connected to the side walls of the pouring spout portion 6 for permanent arrangement of the squeezing means 7 on the container 1. More specifically, the squeezing means 7 is arranged on the outside of the side walls 2 of the container. To provide a good permanent connection to the container 1, the connecting portions 20, 21 are advantageously plane, as shown.

The first Z1 and the third zone Z3 are arranged relative to each other so as to form an angle α to each other when the squeezing means is in its closed position, see FIG. 6. When opening the squeezing means 7, see FIG. 5, and locking the second leg 10 to the rear end portion, the connecting portions 20, 21 of the two legs 9, 10 form the same angle α to the first zone Z1. This means that the first zone Z1, with the squeezing means 7 arranged in its open state, will coincide with the plane that is made up by the joining portion 40 of the container 1. Thus, the squeezing means 7 will in its open state strive to expand an opening in the pouring spout portion 6 which is symmetrical around said joining portion 40, thus minimising the risk of spillage.

Finally, below said third zone Z3 there is a fourth zone Z4 in the form of closing portions 22, 23. The purpose of the closing portions 22, 23 is to ensure that the container 1 is closed in the closed state of the squeezing means 7.

The closing portions 22, 23 may be provided with complimentarily formed grooves and countersinks (not shown).

In the following, the opening and locking function of the squeezing means 7 will be described with reference to FIG. 5. The outer upper end of the second leg 10 forms a gripping means 25 in the form of a lever. The gripping means 25 has on its outside a knurled gripping portion 17. A corresponding gripping portion 17 is arranged on the opposite part of the first leg 9.

A force is applied to the gripping portions 17 to open the squeezing means 7. Due to this force, the legs 9, 10 are forced to be separated. More specifically, the legs 9, 10 are separated by the second leg 10 being turned in said joint means 19. Thus the joint means 19 provides a hinge function. To lock the squeezing means in this opened position, the latch 15 engages the lug 16 of the joining means 11.

To reclose the container, a bending outward force is applied to an upper part of the gripping means 25, whereby the latch 15 is disengaged from the lug 16. Due to the angle α between the first and the third zone Z1, Z3, the legs 9, 10 will strive to return to their initial position, that is to the put-together state. As a result, the opening in the container is closed by the closing portions closing together and, between them, compressing the two side walls 2 in the opening portion 6 of the container. For a tight closure, a force is applied to the legs 9, 10 in the fourth zone Z4, whereby the latch 13 of the first locking means 12 engages the lower end of the second leg 10. The squeezing means 7 is now in its closed, locked position and the container 1 is reclosed.

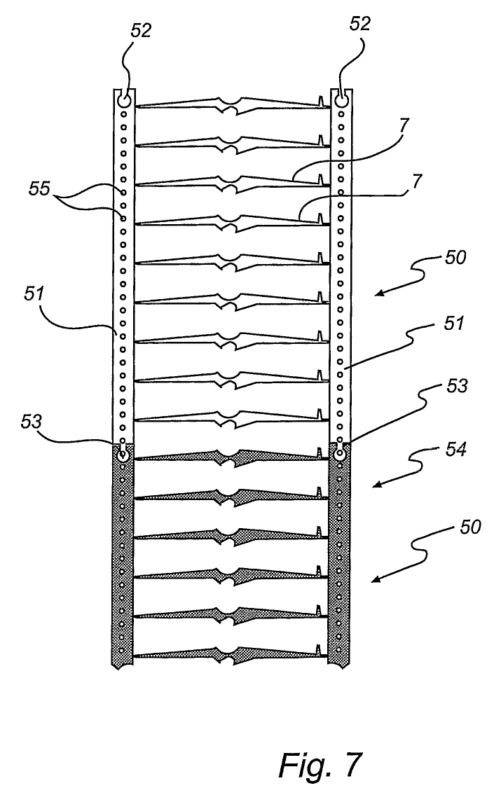

Reference is now made to FIG. 7, which illustrates an injection-moulded carrier 50 with a plurality of squeezing means 7 according to the above-mentioned second embodiment. The carrier 50 is injection moulded in one piece and comprises nine squeezing means 7 in the shown embodiment. The squeezing means 7 are interconnected via outer longitudinal joining portions 51 which extend in the longitudinal direction of the carrier 50. The joining portions 51 have at their ends recesses 52 and protrusions 53 respectively, by means of which a plurality of carriers as shown can be interconnected to form a continuous web 54. Such a web 54 may, for example, be wound onto a bobbin (not shown) to be supplied to a packing machine. To facilitate feeding of such a web 54, the joining portions 51 are perforated 55, whereby the web is allowed to be fed by toothed wheels (not shown).

Two embodiments of the squeezing means 7 have been described above. Irrespective of the embodiment, the connecting portions 20, 21 can advantageously be attached to the opposite side walls 2 of the pouring spout portion 6 by means of an adhesive (not shown), such as an adhesive tape or a hot-melt adhesive. It is also possible to attach the connecting portion 20, 21 to said side walls by welding. If adhesive tape is used, it is advantageous to arrange a strip of adhesive tape with protective tape on the container blank in connection with the manufacture thereof. In connection with the mounting of the squeezing means, which advantageously occurs at a later stage in connection with filling and sealing, the protective strip is removed to obtain the permanent connection. Such a strip of adhesive tape allows continuous webs of container blanks to be wound onto rolls, which blanks are ready for filling and application of closure means 7.

By the squeezing means 7 being arranged on the outside of the pouring spout portion 6, the walls of the container 1 need not be broken when mounting the squeezing means 7, which results in the advantage that the risk of contamination of the interior of the container is eliminated.

The squeezing means 7 is advantageously made in one piece, for instance by injection moulding of a plastic material. The plastic material may contain an addition of a mineral material. Moreover, the squeezing means is advantageously made of one and the same material which has such flexibility and flexural rigidity that the above described flexibility of the squeezing means 7 is allowed.

The selected plastic material may be coloured, or alternatively the squeezing means may be coloured to distinctly distinguish the squeezing means from the container.

It will be appreciated that the present invention should not be restricted to the embodiments illustrated and should only be defined by the appended claims.

1. A container for liquid contents, comprising a closure means for reclosing the container, said container having a pouring spout portion made of two opposite side walls and provided with a removable end flap,
wherein the closure means comprises a squeezing means permanently arranged on said pouring spout portion, said squeezing means comprising
a first and a second leg which are joined to each other by a joining means,
a connecting portion permanently connected to said pouring spout portion, and
a joint means which is arranged between said joining means and said connecting portion to allow mutual relative turning of the first and the second leg in the joint means for opening and closing of the squeezing means,
the squeezing means being movable to an open and a closed state respectively, and
the squeezing means in its closed state being arranged to serve to compress said side walls.

2. A container as claimed in claim 1, in which each leg comprises a closing portion, which closing portions in the closed state of the squeezing means face each other for compression of said side walls.

3. A container as claimed in claim 1, in which the connecting portion is arranged on at least one of the first and the second leg.

4. A container as claimed in claim 1, in which said squeezing means further comprises gripping portions to allow application of force to the legs for opening and closing of the squeezing means.

5. A container as claimed in claim 1, in which the squeezing means is permanently arranged on said pouring spout portion of the container by means of an adhesive.

6. A container as claimed in claim 1, in which the squeezing means further comprises a first locking means for locking the squeezing means in its closed state.

7. A container as claimed in claim 1, in which the squeezing means further comprises a second locking means for locking the squeezing means in its open state.

8. A container as claimed in claim 1, in which the connecting portions extend along half the length of the legs, and whereby the connecting portions are permanently arranged on the pouring spout portion by means of an adhesive.

9. A closure means for reclosing a liquid containers, the closure comprising:
a squeezing means comprising a first and a second leg which are joined to each other by a joining means,
at least one connecting portion which is permanently connectable to a pouring spout portion, made of two side walls of the container, adjacent to a removable end flap of the pouring spout portion, and
a joint means which is arranged between said joining means and said connecting portion to allow mutual relative turning of the first and the second leg in the joint means for opening and closing of the squeezing means,
the squeezing means being movable to an open and a closed state respectively, and
the squeezing means in its closed state being arranged to serve to compress said side walls.

10. Use of a closure means according to claim 9 for opening and reclosing a container for liquid contents, said container having a pouring spout portion made of two opposite side walls and provided with a removable end flap.
